(19) United States
(12) Patent Application Publication
(10) Pub. No.: US 2026/0291041 A1
(43) Pub. Date: Sep. 24, 2026

(54) BATTERY CELL AND BATTERY CELL MANUFACTURING METHOD

(71) Applicant: SK ON CO., LTD., Seoul (KR)

(72) Inventor: Yea-Eun KIM, Daejeon (KR)

(21) Appl. No.: 19/167,827

(22) PCT Filed: Apr. 19, 2024
(86) PCT No.: PCT/KR2024/005339

§ 371 Date: Sep. 22, 2025

(30) Foreign Application Priority Data
Jun. 8, 2023 (KR) 10-2023-0073534

(51) Int. Cl. H01M 50/655; H01M 10/04; H01M 50/60

(52) U.S. Cl. CPC H01M 50/655; H01M 10/049; H01M 50/668

(57) ABSTRACT

Provided according to the present disclosure are a battery cell and a battery cell manufacturing method, the battery cell comprising: a case including an accommodation space in which an electrode assembly is accommodated; an injection passage which is formed in the case and through which an electrolyte is injected into the accommodation space; a first cap detachably coupled to the injection passage; and a second cap detachably coupled to the first cap.

### TECHNICAL FIELD

The present disclosure relates to a battery cell and a battery cell manufacturing method.

### BACKGROUND ART

Unlike primary batteries, battery cells may generally be charged with and discharged of electricity so as to be applied to devices within various fields, such as digital cameras, mobile phones, laptops, hybrid vehicles, and electric vehicles.

Battery cells may be divided into lithium-ion batteries, nickel-cadmium batteries, nickel-metal hydride batteries, etc., depending on materials used for positive electrodes, negative electrodes, or electrolytes and may also be classed as can-type and pouch-type battery cells based on forms thereof. Can-type battery cells may include prismatic and cylindrical battery cells.

Can-type battery cells may be manufactured through a process of injecting electrolyte into an electrode assembly accommodation space located inside through an electrolyte injection passage formed in a battery cell case and finally sealing the electrolyte injection passage.

### DISCLOSURE OF INVENTION

### Technical Problem

During a process of injecting the electrolyte through the electrolyte injection passage, the electrolyte may splash out of the battery cell. Furthermore, since the electrolyte injection passage remains open after electrolyte injection, a phenomenon in which the electrolyte evaporates may occur. In this case, the electrolyte accommodated within the case may become insufficient.

An aspect of the present disclosure is to prevent a phenomenon of electrolyte splashing when an electrolyte is injected into a battery cell.

An aspect of the present disclosure is to reduce the amount of electrolyte evaporation in a battery cell.

An aspect of the present disclosure is to increase the amount of electrolyte injected into a battery cell.

An aspect of the present disclosure is to easily replenish a battery cell with an electrolyte.

The battery cell and battery cell manufacturing method of the present disclosure may be widely applied in green technology fields, such as electric vehicles, battery charging stations, and solar and wind power generation using batteries. Furthermore, the battery cell and battery cell manufacturing method of the present disclosure may be used in eco-friendly electric vehicles, hybrid vehicles, and the like preventing climate change by reducing air pollution and greenhouse gas emissions.

### Solution to Problem

According to an aspect of the present disclosure, a battery cell may include: a case including an accommodation space accommodating an electrode assembly; an injection passage formed in the case and through which an electrolyte is injected into the accommodation space; a first cap detachably coupled to the injection passage; and a second cap detachably coupled to the first cap.

In an embodiment, the first cap may include a first portion disposed to be perpendicular to a length direction of the injection passage and a second portion disposed to be parallel to the length direction of the injection passage, and the first portion may include an electrolyte injection hole connected to the accommodation space.

In an embodiment, the injection passage may include a protrusion extending outwardly from the case.

In an embodiment, the first portion may be disposed inside the injection passage.

In an embodiment, a diameter of the electrolyte injection hole may be less than a diameter of the injection passage.

In an embodiment, the battery cell may further include a first plate sealing the electrolyte injection hole.

In an embodiment, the battery cell may further include an insulating cover detachably coupled to an outer surface of the case, wherein the insulating cover may include an opening in which the protrusion may be disposed.

In an embodiment, the second portion may extend into the inside of the accommodation space, and the first portion may be formed to be disposed inside the second portion.

In an embodiment, the second portion may be fitted into the case.

In an embodiment, the first portion may be formed to be concave in an inward direction of the accommodation space.

According to an aspect of the present disclosure, a battery cell manufacturing method may include: a case preparation operation of preparing a case including an accommodation space accommodating an electrode assembly and an injection passage through which an electrolyte may be injected into the accommodation space; an electrode assembly accommodation operation of accommodating the electrode assembly in the accommodation space; a first cap coupling operation of coupling a first cap to the injection passage; an electrolyte injection operation of injecting the electrolyte into an electrolyte injection hole formed in the first cap; and a second cap coupling operation of coupling a second cap to the first cap.

In an embodiment, the battery cell manufacturing method may further include: a second cap removal operation of removing the second cap from the first cap; and an electrolyte replenishment operation of additionally injecting the electrolyte through the electrolyte injection hole.

In an embodiment, the battery cell manufacturing method may further include: a second cap removal operation of removing the second cap; and a degassing operation of degassing through the electrolyte injection hole.

In an embodiment, the battery cell manufacturing method may further include: a cap removal operation of removing the first cap and the second cap; and an injection passage sealing operation of sealing the injection passage.

In an embodiment, the injection passage may include a protrusion extending outwardly from the case, the cap removal operation may include a process of removing the protrusion, and the injection passage sealing operation may include a process of sealing the injection passage from which the protrusion was removed.

In an embodiment, in the injection passage sealing operation, the injection passage may be sealed by welding.

In an embodiment, in the injection passage sealing operation, the injection passage may be covered with a second plate to be sealed.

### Advantageous Effects of Invention

According to an embodiment of the present disclosure, a phenomenon of electrolyte splashing may be prevented when an electrolyte is injected into a battery cell.

According to an embodiment of the present disclosure, the amount of electrolyte evaporation in a battery cell may be reduced.

According to an embodiment of the present disclosure, the amount of electrolyte injected into a battery cell may be increased.

According to an embodiment of the present disclosure, a battery cell may be easily replenished with an electrolyte.

### BRIEF DESCRIPTION OF DRAWINGS

FIG. 1 is a perspective view of a battery cell according to an embodiment of the present disclosure.

FIG. 2 is a perspective view of the battery cell illustrated in FIG. 1 in which first and second caps are separated.

FIG. 3 is a schematic diagram illustrating that an electrolyte is injected into a battery cell using an electrolyte injection device.

FIG. 4 is a cross-sectional perspective view of the first and second caps, taken along line I-I′ of FIG. 2.

FIG. 5 is a cross-sectional view in which the first and second caps of FIG. 4 are coupled to an injection passage.

FIG. 6 is a cross-sectional view illustrating an example of a final product form of a battery cell.

FIG. 7 is a cross-sectional view illustrating a first cap to which a first plate is coupled.

FIG. 8 is a cross-sectional view of a battery cell to which an insulating cover is coupled.

FIG. 9 is a cross-sectional view illustrating a modified example of the first cap.

FIG. 10 is a cross-sectional view illustrating another modified example of the first cap.

FIGS. 11 to 13 are flowcharts illustrating a method of manufacturing a battery cell according to an embodiment of the present disclosure.

### MODE FOR THE INVENTION

Prior to the description of the present disclosure, terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Hereinafter, preferred embodiments of the present invention will be described in detail with reference to the accompanying drawings. In this case, in the drawings, the same components are denoted by the same reference symbols as possible. Further, the detailed description of well-known functions and constructions which may obscure the gist of the present invention will be omitted. For the same reason, some of the elements in the accompanying drawings are exaggerated, omitted, or schematically illustrated, and the size of each element does not entirely reflect the actual size.

An embodiment of the present disclosure relates to a battery cell and a battery cell manufacturing method, which includes detachably coupling a first cap to an electrolyte injection passage and detachably coupling a second cap to the first cap to minimize the contact area between an injection passage and the outside, thereby reducing a phenomenon of electrolyte splashing and electrolyte evaporation and facilitating electrolyte replenishment.

The terms “first,” “second,” etc., used in the present disclosure are described in a cardinal, not ordinal, sense.

The term “battery cell” as used in the present disclosure encompasses both a final finished battery cell and an intermediate battery cell assembly in an intermediate stage. Hereinafter, a battery cell and a battery cell manufacturing method according to the present disclosure will be described in detail with reference to the drawings.

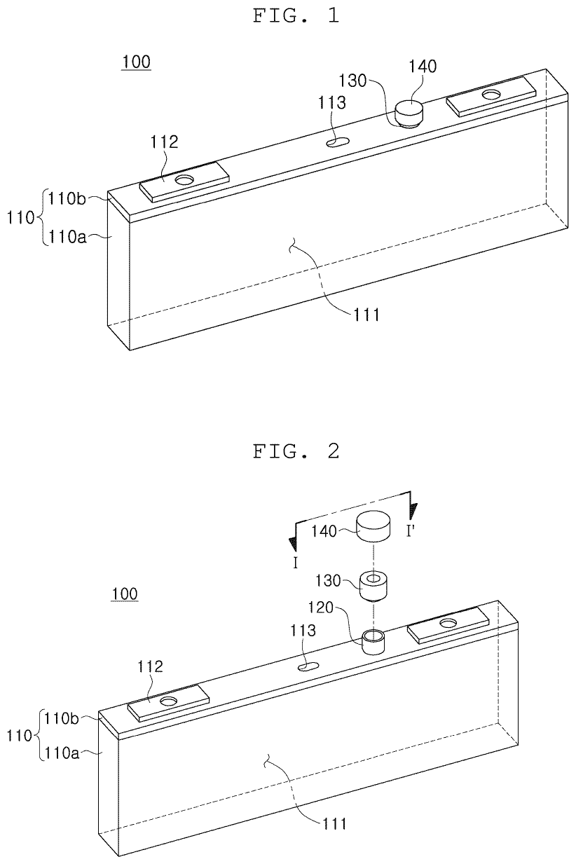

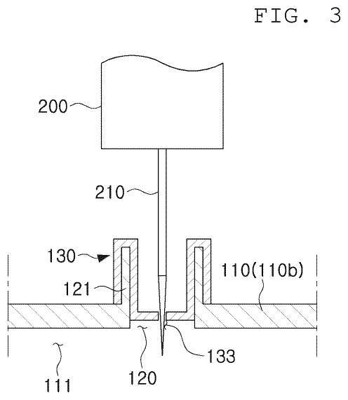

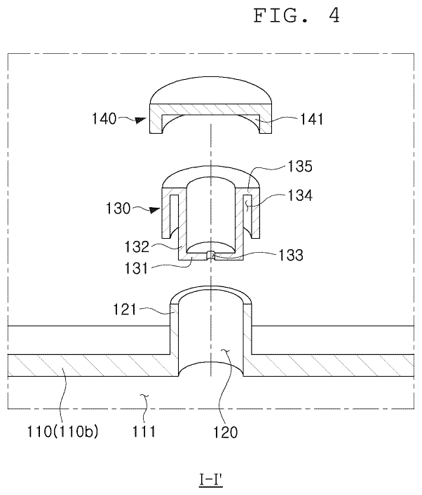

FIG. 1 is a perspective view of a battery cell 100 according to an embodiment of the present disclosure. FIG. 2 is a perspective view of the battery cell illustrated in FIG. 1 in which a first cap 130 and a second cap 140 are separated. FIG. 3 is a schematic diagram illustrating that an electrolyte is injected into a battery cell using an electrolyte injection device 200.

Referring to FIGS. 1 to 3, the battery cell 100 according to an embodiment of the present disclosure may be configured as a secondary battery. The battery cell 100 is described herein as a prismatic battery cell 100 by way of an example, the shape of the battery cell 100 is not limited to a hexahedral structure.

The battery cell 100 may include a case 110, an injection passage 120, a first cap 130, and a second cap 140.

The case 110 may form the exterior of the battery cell 100 and may be formed of aluminum or a material containing aluminum. However, the material of the case 110 is not limited thereto. Furthermore, the case 110 may have a flat, angular hexahedral shape.

The case 110 may include an accommodation space 111, an electrode terminal 112, and a venting portion 113.

The case 110 may include the accommodation space 111 accommodating an electrode assembly. The accommodation space 111 accommodates the electrode assembly and electrolyte to enable charging and discharging of the battery cell 100 and may be included within an internal space of the case 110. The case 110 may include a case body 110a forming the accommodation space 111 and a cap plate 110b covering the accommodation space 111 of the case body 110a.

The electrode assembly may include a plurality of electrode plates and a plurality of separators. The electrode plates may include a positive electrode plate and a negative electrode plate. The separator may be formed of an insulator interposed between the negative electrode plate and the positive electrode plate. The electrode assembly may be configured as a stack-type electrode assembly in which negative electrode plates, positive electrode plates, and separators are alternately stacked or as a jelly roll-type electrode assembly in which stacked negative electrode plates, positive electrode plates, and separators are rolled together. The negative electrode plate and positive electrode plate may each have a structure in which a foil is coated with a negative electrode active material or a positive electrode active material. For example, the negative electrode plate may be formed by coating a copper or nickel foil with graphite or the like, and the positive electrode plate may be formed by coating an aluminum foil with a transition metal oxide active material.

The electrode terminal 112 may be included in the case 110. The electrode terminal 112 may be disposed on the cap plate 110b of the case 110. The electrode terminal 112 may include a positive electrode terminal connected to the positive electrode plate and a negative electrode terminal connected to the negative electrode plate. The positive electrode terminal may be connected to the positive electrode plate via a positive electrode tab extending from the positive electrode plate, and the negative electrode terminal may be connected to the negative electrode plate via a negative electrode tab extending from the negative electrode plate.

The venting portion 113 may be installed in the case 110. For example, the venting portion 113 may be installed in the cap plate 110b. The venting portion 113 may be fixed to the case 110 by welding, such as laser welding. The venting portion 113 may be configured to discharge gases occurring within the case 110. For example, the venting portion 113 may be configured to be ruptured when the internal pressure of the case 110 increases due to gas or the like. The installation location and number of the venting portions 113 may vary. For example, the venting portion 113 may also be installed in the case body 110a.

The injection passage 120 may be formed in the case 110 and may be a passage through which an electrolyte is injected into the accommodation space 111. The injection passage 120 may be formed in the case 110 in the form of a hole connecting the outside and the accommodation space 111. The injection passage 120 may be disposed in the cap plate 110b of the case 110, and an installation position thereof may be changed variously. As illustrated in FIG. 3, in the case of injecting an electrolyte into a battery cell, an electrolyte injection needle 210 of the electrolyte injection device 200 may be inserted into the injection passage 120 to inject the electrolyte into the accommodation space 111 of the case 110. In addition, a cross-section of the injection passage 120 may be formed to have a circular shape as illustrated in FIG. 2. The injection passage 120 may include a protrusion 121 extending outwardly from the case 110, as illustrated in FIG. 2. Therefore, the protrusion 121 allows additional electrolyte to be injected into the battery cell 100 by the amount of space the injection passage 120 extends outwardly. The cross-section of the injection passage 120 and the shape of the protrusion 121 illustrated in the present disclosure are merely examples, and the cross-sections and shapes may vary. For example, the cross-section of the injection passage 120 may be rectangular, and the shape of the protrusion 121 may also be a square pillar.

The first cap 130 may be coupled to the injection passage 120 of the case 110. The first cap 130 may be coupled so that a central axis thereof is aligned with the injection passage 120. The first cap 130 may be detachably coupled to the injection passage 120. Accordingly, the process of coupling the first cap 130 to the injection passage 120 or removing the first cap 130 from the injection passage 120 may be repeated.

The second cap 140 may be coupled to the first cap 130. The second cap 140 may be coupled so that a central axis thereof is aligned with the first cap 130. The second cap may be detachably coupled to the first cap 130. Accordingly, the process of coupling the second cap 140 to the first cap 130 or removing the second cap 140 from the first cap 130 may be repeated.

The first cap 130 and the second cap 140 may be coupled by a fitting method. Therefore, the first cap 130 and the second cap 140 ensure that the case 110 remains securely sealed after being coupled and prevent unintended electrolyte leakage or evaporation. At the same time, the first cap 130 and the second cap 140 may be removed if necessary. However, the method of coupling the first cap 130 and the second cap 140 is not limited to a fitting method. Any method ensuring that the case 110 remains securely sealed, preventing unintended electrolyte leakage or evaporation, and allowing for removal when necessary may be used. For example, a screw-coupling method may also be used as a coupling method.

The first cap 130 and the second cap 140 may be formed of various materials, such as metal, rubber, or plastic. In addition, to maintain a stably coupled state, a friction member, such as rubber or silicone, may be additionally attached to surfaces of the first cap 130 and the second cap 140.

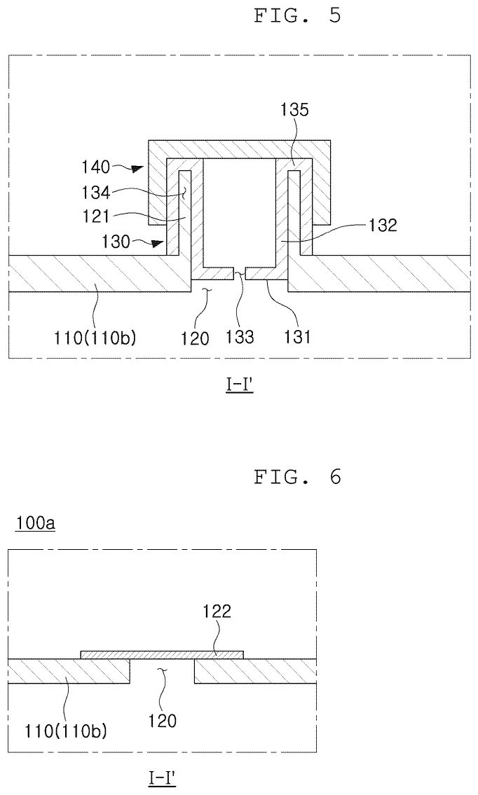

FIG. 4 is a cross-sectional perspective view of the first cap 130 and the second cap 140, taken along line I-I′ of FIG. 2, and FIG. 5 is a cross-sectional view of the first cap 130 and the second cap 140 shown in FIG. 4, coupled to the injection passage.

Referring to FIGS. 4 and 5, the first cap 130 may include a first portion 131, a second portion 132, an electrolyte injection hole 133, a protrusion accommodation portion 134, and a cap head 135.

The first portion 131 may be disposed to be perpendicular to a length direction (an electrolyte injection direction) of the injection passage 120. The first portion 131 may be disposed within the injection passage 120. A depth to which the first portion 131 is introduced into the injection passage 120 may vary as needed, taking into account factors, such as a length of the electrolyte injection needle (210 in FIG. 3), a length of the protrusion 121, and an injection amount of electrolyte. The first portion 131 may be circular, like the injection passage 120. A diameter of the first portion 131 may be equal to or greater than a diameter of the injection passage 120 so that the first cap 130 and the injection passage 120 are fitted together.

The second portion 132 may be connected to the edge of the first portion 131 and may be disposed parallel to the length direction of the injection passage 120. At least a portion of the second portion 132 may be disposed within the injection passage 120. The first portion 131 may be disposed at one end of the second portion 132. A length of the second portion 132 may vary as needed, taking into account factors, such as the length of the electrolyte injection needle 210, the length of the protrusion 121, and the injection amount of electrolyte.

The electrolyte injection hole 133 may be used when injecting the electrolyte while the first cap 130 is coupled to the injection passage 120. When injecting the electrolyte into the battery cell 100, as illustrated in FIG. 3, the electrolyte injection needle 210 of the electrolyte injection device 200 may inject the electrolyte into the accommodation space 111 of the case 110 through the injection hole of the first cap 130 coupled to the injection passage 120. The first portion 131 may include an electrolyte injection hole 133 connected to the accommodation space 111. The electrolyte injection hole 133 may be disposed in the first portion 131. A diameter of the electrolyte injection hole 133 may be less than a diameter of the injection passage 120. Specifically, the diameter of the electrolyte injection hole 133 may be less than the diameter of the first portion 131. Therefore, when the first cap 130 is coupled to the injection passage 120, the area of the injection passage 120 exposed to the outside may be reduced, thereby minimizing electrolyte evaporation. Furthermore, the electrolyte may be injected with the first cap 130 coupled, and a phenomenon of electrolyte splashing occurring when the electrolyte collides with a component of the battery cell 100 during electrolyte injection may be reduced.

The protrusion accommodation portion 134 may be a groove formed in the first cap 130 to accommodate the protrusion 121 of the injection passage 120. The protrusion accommodation portion 134 may be formed on the outside of the second portion 132. The protrusion accommodation portion 134 may accommodate a portion or the entirety of the protrusion 121. The protrusion accommodation portion 134 illustrated in FIG. 5 illustrates a case in which the protrusion accommodation portion 134 accommodates the entire protrusion 121.

The first cap 130 may include the cap head 135 coupled to the second cap 140. The cap head 135 may be connected to the second portion 132 in an upper portion of the first cap 130. The protrusion accommodation portion 134 may be formed between the cap head 135 and the second portion 132. When the protrusion accommodation portion 134 accommodates the entire protrusion 121, one end surface of the cap head 135 may be in contact and aligned with one surface of the case 110.

The second cap 140 may include a cap head accommodation portion 141 to accommodate the cap head 135 of the first cap 130. A cross-section of the cap head 135 and a cross-section of the cap head accommodation portion 141 may be circular. A diameter of the cap head 135 may be greater than or equal to a diameter of the cap head accommodation portion 141 to enable the first cap 130 and the second cap 140 to be fitted together. When the second cap 140 is coupled to the first cap 130, the injection passage 120 is sealed from the outside, thereby maintaining sealing properties.

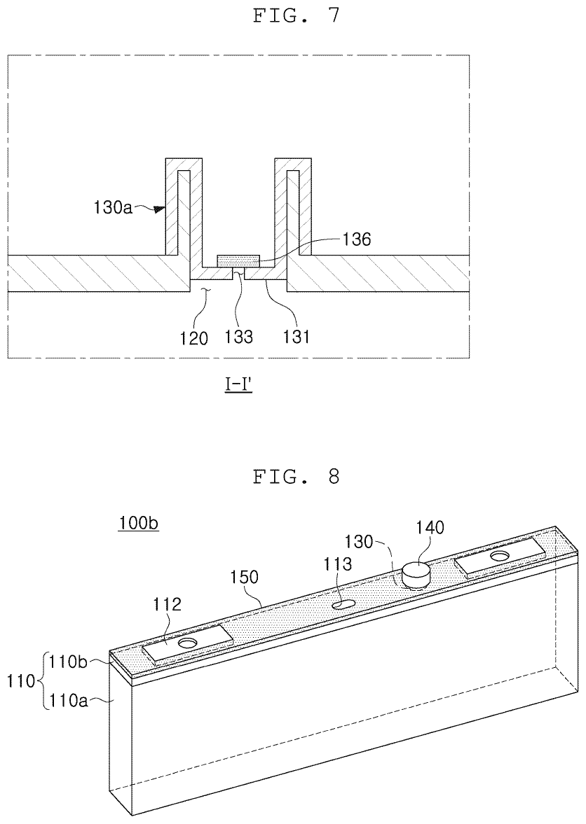

FIG. 6 is a cross-sectional view illustrating an example of a final product form of a battery cell 100a.

Referring to FIG. 6, if the final product of the battery cell 100a does not require additional electrolyte injection, the configuration of the first cap 130, second cap 140, and protrusion 121 may no longer be required. In this case, the final product battery cell 100a may be formed by removing the configuration of the first cap 130, second cap 140, and protrusion 121, and then covering the removed portion with the second plate 122 or welding the removed portion to seal the injection passage 120. A material constituting the second plate 122 may be any material capable of sealing the accommodation space 111 from the outside, such as metal, rubber, or plastic. The method of sealing the injection passage 120 with the second plate 122 may be welding or bonding.

FIG. 7 is a cross-sectional view illustrating a first cap 130a coupled with a first plate 136.

The battery cell 100 may further include the first plate 136 sealing the electrolyte injection hole 133. For example, the first cap 130a may further include the first plate 136. The first plate 136 is a member further enhancing sealing properties when the first cap 130a is coupled to the injection passage 120. The first plate 136 may be coupled to the first portion 131 to block the electrolyte injection hole 133. The first plate 136 may be attached to the first portion 131, but the method of coupling the first plate 136 is not limited thereto. A material of the first plate 136 may include rubber, silicone, or the like. Therefore, when injecting the electrolyte, the electrolyte injection needle (210 in FIG. 3) may be inserted into the injection passage easily through the first plate 136, and after the injection needle 210 is discharged, the first plate 136 may be deformed and the hole through which the injection needle 210 has passed may be narrowed.

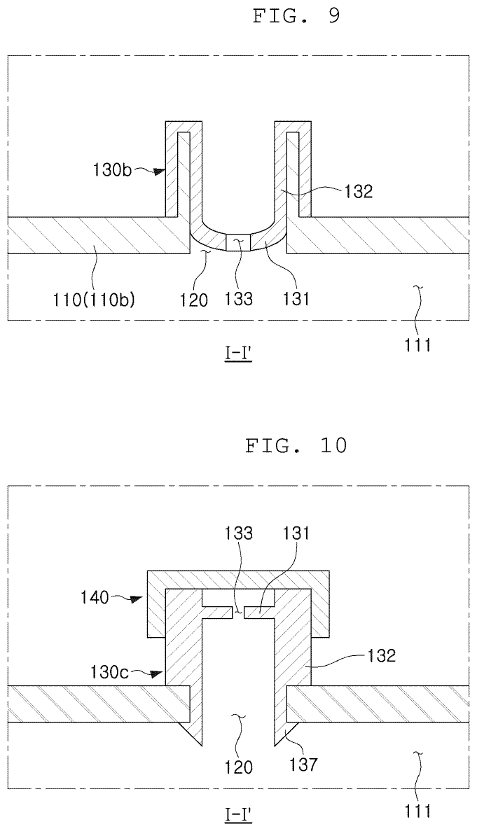

FIG. 8 is a cross-sectional view of a battery cell 100b to which an insulating cover 150 is coupled.

The battery cell 100b may further include the insulating cover 150 detachably coupled to an outer surface of the case 110, and the insulating cover 150 may include an opening in which the protrusion 121 is disposed. The insulating cover 150 may be a member for electrically insulating an upper portion of the battery cell 100 from the outside. The insulating cover 150 may have a shape covering the cap plate 110b. A material of the insulating cover 150 may include an insulating material. For example, the insulating cover 150 may be formed of a synthetic resin, such as polyvinyl chloride, synthetic rubber, polyethylene, or polypropylene, but is not limited thereto. The opening may be a hole formed to allow the protrusion passes therethrough. The insulating cover 150 may include a hole allowing the electrode terminal 112, the venting portion 113, and the first and second caps 130 and 140 to be exposed externally.

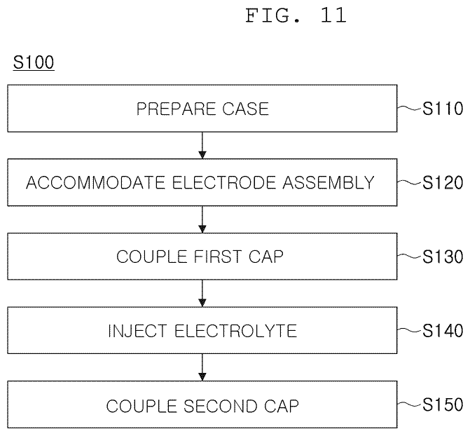

FIG. 9 is a cross-sectional view illustrating a modified example of a first cap 130b.

The first portion 131 of the first cap 130b may be formed to be concave in an inward direction of the accommodation space 111. The concave first portion 131 may serve as a guide to allow the electrolyte injection needle 210 to easily pass through the electrolyte injection hole 133 and may allow the electrolyte remaining within the first cap 130b to flow into the accommodation space 111. The shape of the first portion 131 presented in the present disclosure is merely an example and the first portion 131 may have various shapes. For example, the first portion 131 may have a cone shape narrowing in a direction toward the accommodation space 111.

FIG. 10 is a cross-sectional view illustrating another modified example of a first cap 130c.

The second portion 132 of the first cap 130c may extend into the accommodation space 111. The second portion 132 may be fitted into the case 110. For example, the first cap 130c may have a catch 137 formed at one end of the second portion 132 and may be fitted into the injection passage 120. The first portion 131 may be formed to be disposed within the second portion 132. According to another modified example of the first cap 130c illustrated in FIG. 10, the second portion 132 may replace the protrusion 121, and thus, the injection passage 120 may not include the protrusion 121.

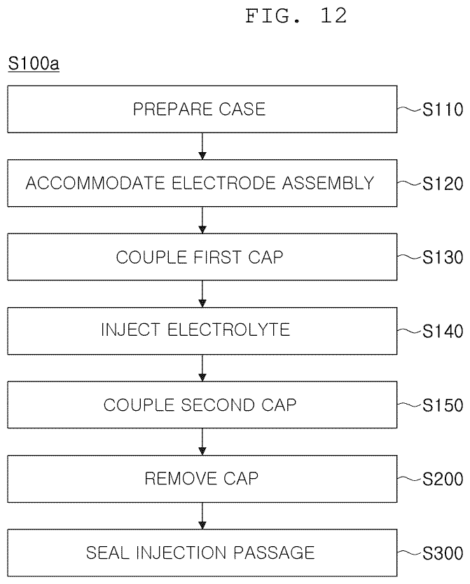

FIGS. 11 to 13 are flowcharts illustrating a method of manufacturing a battery cell according to an embodiment of the present disclosure.

Referring to FIG. 11 together with FIGS. 1 to 3, a battery cell manufacturing method (S100) may include a case preparation operation (S110), an electrode assembly accommodation operation (S120), a first cap coupling operation (S130), an electrolyte injection operation (S140), and a second cap coupling operation (S150).

The case preparation operation (S110) may be an operation of preparing the case 110 accommodating the electrode assembly. The case 110 may include the accommodation space 111 accommodating the electrode assembly and the injection passage 120 for injecting an electrolyte into the accommodation space 111.

In the electrode assembly accommodation operation (S120), the prepared electrode assembly may be accommodated in the accommodation space 111.

In the first cap coupling operation (S130), the first cap 130 may be coupled to the injection passage 120 formed in the case 110. A method of coupling the first cap 130 to the injection passage 120 may be a detachable coupling method, and various coupling methods may be used. According to an embodiment of the present disclosure, coupling may be performed by fitting or screw-coupling. The coupling may be performed manually by a worker or by a battery cell 100 manufacturing device.

The electrolyte injection operation (S140), as illustrated in FIG. 3, may be an operation of injecting an electrolyte into the electrolyte injection hole 133 formed in the first cap 130 using the electrolyte injection device 200. The electrolyte injection needle 210, a component of the electrolyte injection device 200, is inserted into the electrolyte injection hole 133, and the electrolyte is injected through the electrolyte injection needle 210. At this time, the electrolyte injection needle 210 may be prevented from touching the electrode assembly within the accommodation space 111.

The second cap coupling operation (S150) may be an operation of coupling the second cap 140 to the first cap 130. At this time, the first cap 130 is in a state of being coupled to the injection passage 120. The coupling method of the second cap 140 may be a detachable coupling method and may be the same as or different from the coupling method of the first cap 130. For example, the coupling method of the second cap 140 may be fitting coupling or screw coupling.

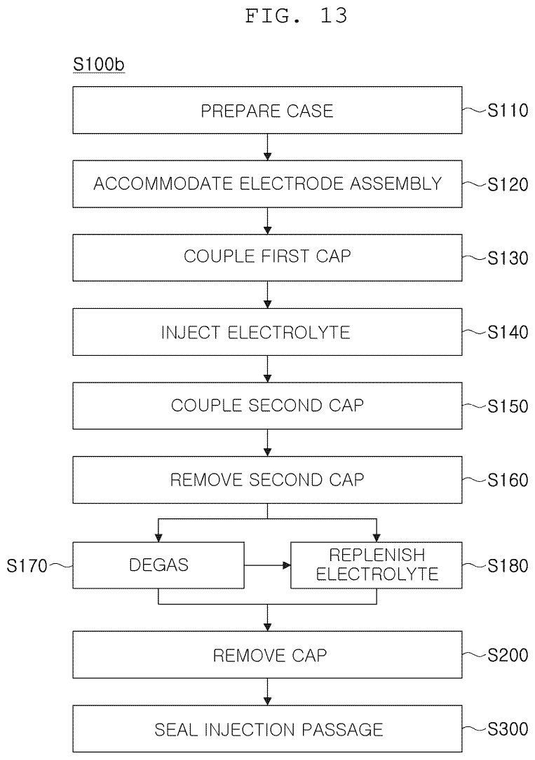

As illustrated in FIG. 12, a battery cell manufacturing method (S100a) may further include a cap removal operation (S200) and an injection passage sealing operation (S300).

The cap removal operation (S200) may be an operation of removing the first cap 130 and the second cap 140. The first and second caps 130 and 140 may be removed by cutting, but this is merely an example, and the removal method may vary. The cap removal operation (S200) may include a process of removing the protrusion 121. The protrusion 121 is formed to extend the injection passage 120 to the outside of the case 110. Therefore, after the cap removal operation (S200), the protrusion 121 may or may not remain in the case 110.

The injection passage sealing operation (S300) may include a process of sealing the injection passage from which the protrusion 121 has been removed. This may be an operation of sealing the remaining injection passage 120 after the first and second caps 130 and 140 are removed. If the protrusion 121 has been removed, the injection passage sealing operation (S300) may be an operation of sealing the injection passage 120 remaining after the protrusion 121 has been removed. At this time, the injection passage sealing operation (S300) may be an operation of sealing the injection passage 120 by welding or covering the injection passage 120 with the second plate 122 for sealing. As illustrated in FIG. 6, the second plate 122 is configured to cover the upper portion of the injection passage from the outer surface of the case. A material of the second plate 122 may be any material capable of sealing the accommodation space 111 so as to be blocked from the outside, such as metal, rubber, or plastic. A sealing method of the second plate 122 may be welding or bonding. However, this is merely an example, and the sealing method of the second plate 122 may vary.

As illustrated in FIG. 13, a battery cell manufacturing method (S100b) may further include a second cap removal operation (S160), a degassing operation (S170), and an electrolyte replenishment operation (S180).

The second cap removal operation (S160) may be an operation of removing the second cap 140 from the first cap 130. With the second cap 140 removed, the first cap 130 may remain coupled to the injection passage 120.

After the second cap removal operation (S160), the degassing operation (S170) or the electrolyte replenishment operation (S180) may be performed, as needed.

The degassing operation (S170) may be an operation of degassing gas generated within the accommodation space 111 through the electrolyte injection hole 133. During the manufacturing process of the battery cell 100, the battery cell 100 undergoes a charging/discharging and stabilization process. During this process, gas may be generated in the accommodation space within the battery cell 100 and there may be a need for removing the gas. After the degassing operation (S170), the electrolyte replenishment operation (S180) may be additionally performed.

The electrolyte replenishment operation (S180) may be an operation of additionally injecting an electrolyte through the electrolyte injection hole 133. The injection needle 210 of the electrolyte injection device 200 may be inserted into the exposed injection hole 133 of the first cap 130 to inject the electrolyte. The replenishment amount of electrolyte may vary depending on the amount of evaporated or insufficient electrolyte.

After the degassing operation (S170) or the electrolyte replenishment operation (S180), the cap removal operation (S200) and the injection passage sealing operation (S300) may be further performed.

Although the embodiments of the present disclosure have been described above, the scope of the present disclosure is not limited thereto and it will be apparent to those skilled in the art that various modifications and variations may be made within the scope not departing from the technical idea of the present disclosure described in the claims.

For example, the present disclosure may be implemented by deleting some of the components in the above-described embodiments, and the respective embodiments may be implemented in combination with each other.

### DESCRIPTION OF REFERENCE CHARACTERS

100: BATTERY CELL
110: CASE
110A: CASE BODY
110B: CAP PLATE
111: ACCOMMODATION SPACE
112: ELECTRODE TERMINAL
113: VENTING PORTION
120: INJECTION PASSAGE
121: PROTRUSION
122: SECOND PLATE
130: FIRST CAP
131: FIRST PORTION
132: SECOND PORTION
133: ELECTROLYTE INJECTION HOLE
134: PROTRUSION ACCOMMODATION PORTION
135: CAP HEAD
136: FIRST PLATE
137: CATCH
140: SECOND CAP
141: CAP HEAD ACCOMMODATION PORTION
150: INSULATING COVER
200: ELECTROLYTE INJECTION DEVICE
210: ELECTROLYTE INJECTION NEEDLE

1. A battery cell comprising:
a case including an accommodation space accommodating an electrode assembly;
an injection passage formed in the case and through which an electrolyte is injected into the accommodation space;
a first cap detachably coupled to the injection passage; and
a second cap detachably coupled to the first cap.

2. The battery cell of claim 1, wherein
the first cap includes a first portion disposed to be perpendicular to a length direction of the injection passage and a second portion disposed to be parallel to the length direction of the injection passage, and
the first portion includes an electrolyte injection hole connected to the accommodation space.

3. The battery cell of claim 2, wherein the injection passage includes a protrusion extending outwardly from the case.

4. The battery cell of claim 2, wherein the first portion is disposed inside the injection passage.

5. The battery cell of claim 2, wherein a diameter of the electrolyte injection hole is less than a diameter of the injection passage.

6. The battery cell of claim 2, further comprising a first plate sealing the electrolyte injection hole.

7. The battery cell of claim 3, further comprising
an insulating cover detachably coupled to an outer surface of the case,
wherein the insulating cover includes an opening in which the protrusion is disposed.

8. The battery cell of claim 2, wherein the second portion extends into the inside of the accommodation space, and the first portion is formed to be disposed inside the second portion.

9. The battery cell of claim 8, wherein the second portion is fitted into the case.

10. The battery cell of claim 2, wherein the first portion is formed to be concave in an inward direction of the accommodation space.

11. A battery cell manufacturing method comprising:
a case preparation operation of preparing a case including an accommodation space accommodating an electrode assembly and an injection passage through which an electrolyte is injected into the accommodation space;
an electrode assembly accommodation operation of accommodating the electrode assembly in the accommodation space;
a first cap coupling operation of coupling a first cap to the injection passage;
an electrolyte injection operation of injecting the electrolyte into an electrolyte injection hole formed in the first cap; and
a second cap coupling operation of coupling a second cap to the first cap.

12. The battery cell manufacturing method of claim 11, further comprising:
a second cap removal operation of removing the second cap from the first cap; and
an electrolyte replenishment operation of additionally injecting the electrolyte through the electrolyte injection hole.

13. The battery cell manufacturing method of claim 11, further comprising:
a second cap removal operation of removing the second cap; and
a degassing operation of degassing through the electrolyte injection hole.

14. The battery cell manufacturing method of claim 11, further comprising:
a cap removal operation of removing the first cap and the second cap; and
an injection passage sealing operation of sealing the injection passage.

15. The battery cell manufacturing method of claim 14, wherein
the injection passage includes a protrusion extending outwardly from the case,
the cap removal operation includes a process of removing the protrusion, and
the injection passage sealing operation includes a process of sealing the injection passage from which the protrusion was removed.

16. The battery cell manufacturing method of claim 14, wherein, in the injection passage sealing operation, the injection passage is sealed by welding.

17. The battery cell manufacturing method of claim 14, wherein, in the injection passage sealing operation, the injection passage is covered with a second plate to be sealed.
